(19) United States
(12) Patent Application Publication
(10) Pub. No.: US 2016/0245311 A1
(43) Pub. Date: Aug. 25, 2016

(54) Hydraulic Pressure Circuit and Working Machine

(71) Applicant: CATERPILLAR SARL, Geneva (CH)

(72) Inventors: Shigeo Kajita, Tokyo (JP); Kouji Kishida, Tokyo (JP); Shogo Tada, Tokyo (JP); Nobuaki Matoba, Hyogo (JP)

(73) Assignee: Caterpillar SARL, Geneva (CH)

(21) Appl. No.: 15/032,258

(22) PCT Filed: Nov. 4, 2014
(86) PCT No.: PCT/EP2014/073737

§ 371 Date: Apr. 26, 2016

(30) Foreign Application Priority Data
Nov. 6, 2013 (JP) 2013-230534

(51) Int. Cl. F15B 11/08; F15B 13/02; F15B 13/042; F15B 1/04

(52) U.S. Cl. CPC F15B 11/08; F15B 1/04; F15B 13/025; F15B 13/0426; F15B 2201/00

(57) ABSTRACT

The hydraulic circuit has: main pumps driven by an engine; a boom cylinder including a piston operating by hydraulic oil supplied from the main pumps, one chamber and the other chamber respectively partitioned and formed by the piston; an accumulator accumulating pressure of the hydraulic oil extruded from one chamber of the boom cylinder; and an assist pump motor suctioning the hydraulic oil from the accumulator when pressure continues to be accumulated in the accumulator and the accumulator pressure rises.

### TECHNICAL FIELD

The present invention relates to a hydraulic pressure circuit having an accumulator and a working machine on which the hydraulic pressure circuit is mounted.

### BACKGROUND ART

In a working machine, pressurized oil discharged from a boom hydraulic cylinder during a boom lowering operation is accumulated in an accumulator and pressurized oil relieved from a swinging hydraulic motor during acceleration or deceleration of the swinging is also accumulated in the accumulator (for example, see Patent Literature 1).

Patent Literature 1: Japanese Patent Application Publication No. 2010-84888

Since the speed of a boom hydraulic cylinder decreases when accumulation of pressure in an accumulator progresses so that the accumulator pressure increases, the accumulator cannot accumulate to a high pressure level and has to abandon energy. Thus, it is not possible to recycle the energy efficiently.

Moreover, when a circuit is switched to cope with a decrease in the speed of the boom hydraulic cylinder, a shock occurs during the circuit switching, which deteriorates operability. Thus, it is not desirable to switch the circuit to cope with the decrease in the speed.

Further, when the boom hydraulic cylinder cooperates with other actuators during the pressure accumulation, oil may be consumed by an actuator having a low pressure level, and the boom may be slowly lowered and may stop.

### DISCLOSURE OF THE INVENTION

The present invention has been made in view of the above problem, and an object thereof is to provide a hydraulic pressure circuit and a working machine capable of solving a problem that the speed of a hydraulic pressure cylinder decreases when an accumulator pressure increases without switching a circuit, which may deteriorate operability, and recycling energy efficiently.

An invention according to claim 1 is a hydraulic pressure circuit including: a main pump driven by an engine; a hydraulic pressure cylinder including a piston operated with an operating fluid supplied from the main pump and one chamber and another chamber partitioned by the piston; an accumulator that accumulates the operating fluid pushed from the one chamber of the hydraulic pressure cylinder; and an assist pump that sucks in the operating fluid from the accumulator when pressure accumulation in the accumulator progresses such that an accumulator pressure increases.

An invention according to claim 2 is the hydraulic pressure circuit according to claim 1, in which the assist pump pressurizes the operating fluid sucked from the accumulator and supplies the pressurized operating fluid to the other chamber of the hydraulic pressure cylinder.

An invention according to claim 3 is the hydraulic pressure circuit according to claim 1 or 2, in which the hydraulic pressure circuit further includes a pressure reducing valve that reduces hydraulic pressure supplied from at least one of the assist pump and the accumulator to a predetermined pressure level; and a pilot circuit that uses operating fluid pressure connected to the pressure reducing valve as a pilot source pressure.

An invention according to claim 4 is a working machine including: a vehicle body; a working unit mounted on the vehicle body; and the hydraulic pressure circuit according to any one of claims 1 to 3, provided in the hydraulic pressure cylinder that operates the working unit.

An invention according to claim 5 is the working machine according to claim 4, in which the working unit includes a boom rotated in a vertical direction, wherein the hydraulic pressure cylinder is a boom cylinder that moves the boom in the vertical direction.

According to the invention disclosed in claim 1, when the pressure accumulation of the accumulator that accumulates the operating fluid pushed from one chamber of the hydraulic pressure cylinder progresses so that the accumulator pressure has increased and the speed of the hydraulic pressure cylinder has decreased, the operating fluid supplied to the accumulator is consumed by the assist pump to thereby suppress an increase in the accumulator pressure. Thus, it is possible to diminish a decrease in the speed of the hydraulic pressure cylinder without switching a circuit and to prevent the occurrence of a shock during the switching, which may occur when a circuit is switched to cope with the decrease in the speed of the hydraulic pressure cylinder.

According to the invention disclosed in claim 2, since the assist pump motor supplies the operating fluid to the other chamber of the hydraulic pressure cylinder, it is possible to reduce the amount of operating fluid supplied from the main pump. Thus, it is possible to suppress an adverse effect on other hydraulic pressure actuators that share the main pump, and to secure the ability to cooperate with the other hydraulic pressure actuators. Moreover, since the energy that has to be consumed in order to maintain the operating speed of the hydraulic pressure cylinder can be recycled efficiently by the assist pump motor, it is possible to suppress energy loss.

According to the invention disclosed in claim 3, since the pressure reducing valve reduces the hydraulic pressure supplied from at least one of the assist pump and the accumulator and uses the same as pilot source pressure, it is possible to eliminate the use of a conventional pilot pump.

According to the invention disclosed in claim 4, the operating fluid supplied to the accumulator mounted on the working machine is consumed by the assist pump to suppress an increase in the accumulator pressure. Thus, it is possible to diminish the decrease in the speed of the working unit and to prevent the occurrence of a shock during the switching, which may occur when a circuit is switched to cope with the decrease in the speed of the working unit.

According to the invention disclosed in claim 5, since a shock occurs during the switching and the operability deteriorates if a circuit is switched to cope with the decrease in the boom lowering speed, by decreasing the amount of the operating fluid pushed from the boom cylinder and accumulated in the accumulator so that the operating fluid is consumed by the assist pump, it is possible to prevent the decrease in the boom lowering speed and to suppress energy loss. Moreover, since the energy that has to be consumed in order to maintain the boom lowering speed can be recycled efficiently by the assist pump motor, it is possible to suppress energy loss.

### BRIEF DESCRIPTION OF THE DRAWINGS

FIG. 1 is a circuit diagram illustrating an embodiment of a hydraulic pressure circuit according to the present invention;

FIG. 2 is a circuit diagram illustrating a switching state of the hydraulic pressure circuit;

FIG. 3A is a circuit diagram illustrating a pressure accumulation state of a swinging motor of the hydraulic pressure circuit and FIG. 3B is a circuit diagram illustrating an example where a pilot circuit uses the accumulated pressure; and

FIG. 4 is a perspective view illustrating an embodiment of a working machine according to the present invention.

### BEST MODE FOR CARRYING OUT THE INVENTION

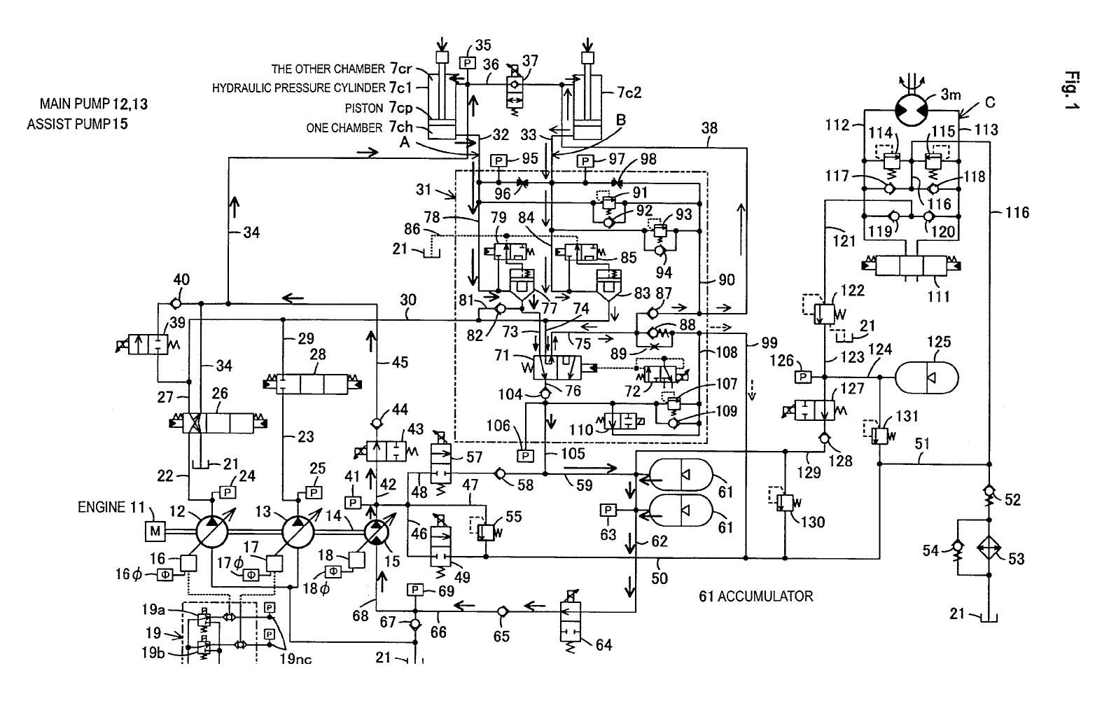

Hereinafter, the present invention will be described in detail according to an embodiment illustrated in FIGS. 1 to 4.

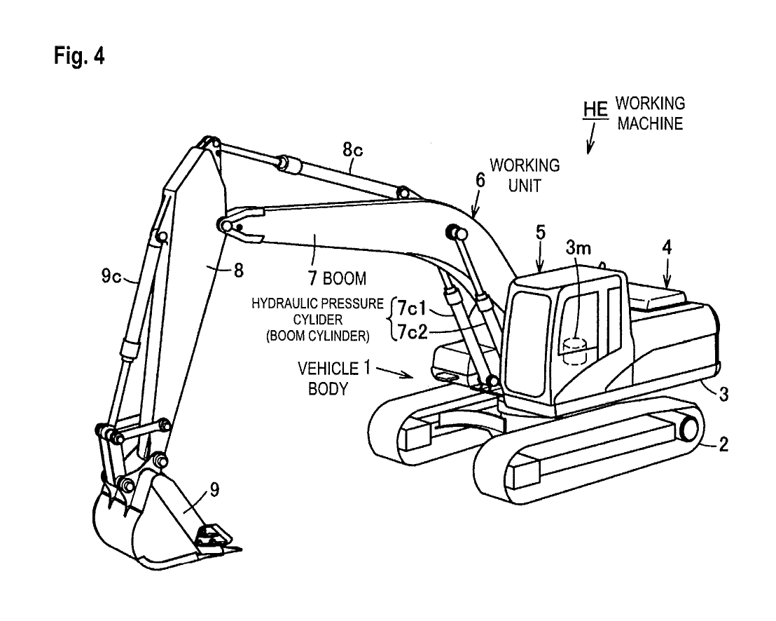

As illustrated in FIG. 4, a vehicle body 1 of an excavator HE as a working machine includes a lower traveling body 2 and an upper swinging body 3 provided on the lower traveling body 2 so as to be swingable by a swinging motor 3m. A machine chamber 4 in which an engine, a pump, and the like are mounted, a cab 5 for protecting an operator, and a working unit 6 are mounted on the upper swinging body 3.

The working unit 6 has a configuration in which a base end of a boom 7 rotated in an vertical direction by two boom cylinders 7c1 and 7c2 as hydraulic pressure cylinders arranged in parallel is supported by the upper swinging body 3, a stick 8 rotated in a front-rear direction by a stick cylinder 8c is supported by a distal end of the boom 7, and a bucket 9 rotated by a bucket cylinder 9c is supported by a distal end of the stick 8. The boom cylinders 7c1 and 7c2 are arranged in parallel in relation to the same boom 7 and perform the same operation simultaneously.

FIG. 1 illustrates an engine power assist system which accumulates the potential energy of the working unit 6 in an accumulator with the aid of the boom cylinder 7c1 and accumulates the kinetic energy of the upper swinging body 3 in the accumulator with the aid of the swinging motor 3m to use the energy in assisting the engine power.

Next, a circuit configuration of this system will be described. The boom cylinders 7c1 and 7c2 are partitioned into one chamber 7ch positioned closer to the head side and the other chamber 7cr positioned closer to the rod side by a single-rod-type piston 7cp that operates with operating oil pressure.

An assist pump motor 15 that serves as a pump having a motor function is connected directly or via gears to a main pump shaft 14 of main pumps 12 and 13 driven by the engine 11 mounted in the machine chamber 4. The main pumps 12 and 13 and the assist pump motor 15 have a swash plate capable of variably adjusting a pump/motor displacement (piston stroke) by adjusting the swash angle (tilt angle). The swash angles (tilt angles) are controlled by regulators 16, 17 and 18 and are detected by swash angle sensors 16φ, 17φ, and 18φ, and the regulators 16, 17, and 18 are controlled by electromagnetic valves. For example, the regulators 16 and 17 of the main pumps 12 and 13 can be controlled automatically by negative flow control pressure (so-called negative control pressure) guided by a negative flow control passage 19nc and can be controlled with signals other than the negative control pressure by electromagnetic switching valves 19a and 19b of a negative flow control valve 19.

The main pumps 12 and 13 discharge operating oil as operating fluid sucked up from a tank 21 to passages 22 and 23, and the pump discharge pressures thereof are detected by pressure sensors 24 and 25. An output passage 27 drawn from one side of a main boom control valve 26 for controlling the boom cylinders 7c1 and 7c2 and an output passage 29 drawn from a sub-boom control valve 28 among pilot-operated direction/flow rate control valves connected to the main pumps 12 and 13 are connected to a boom energy recovery valve 31 as a composite valve by a passage 30.

The boom energy recovery valve 31 is a composite valve in which the functions of a plurality of circuits switching an accumulation circuit A and a regeneration circuit B illustrated in FIG. 1 and a circuit, which is not illustrated, for guiding the pressurized operating oil supplied from the main pumps 12 and 13 during a boom raising operation toward the head side of the two boom cylinders 7c1 and 7c2 are incorporated into a single block. The head-side ends of the two boom cylinder 7c1 and 7c2 are connected to the boom energy recovery valve 31 by passages 32 and 33, respectively.

The other output passage 34 drawn from the main boom control valve 26 is connected to one of the boom cylinders—the boom cylinder 7c1, and a pressure sensor 35 that detects a rod-side pressure of the boom cylinder is provided in the rod-side end. The rod-side ends of the two boom cylinders 7c1 and 7c2 arranged in parallel can communicate with each other with the aid of a bypass passage 36, and the communication between the rod-side ends of the boom cylinders 7c1 and 7c2 can be blocked by an electromagnetic separation valve 37 provided in the middle of the bypass passage 36. The rod-side end of the boom cylinder 7c2 is connected to the boom energy recovery valve 31 by a passage 38.

The output passage 27 drawn from the one side of the main boom control valve 26 can communicate with the other output passage 34 via an electromagnetic switching valve 39 and a check valve 40. Moreover, a pressure sensor 41 is provided on the discharge side of the assist pump motor 15 so as to detect the discharge pressure of the assist pump motor 15, an electromagnetic switching valve 43 is provided in the discharge passage 42, and a passage 45 that passes through a check valve 44 is connected to the output passage 34.

The discharge passage 42 of the assist pump motor 15 branches into three passages 46, 47, and 48. The passage 46 is connected to an electromagnetic unload valve 49, and the connection of the electromagnetic unload valve 49 extends from tank passages 50 and 51 to a spring check valve 52 and then to the tank 21 via and an oil cooler 53 or a spring check valve 54. The passage 47 is connected to a tank passage 50 via a relief valve 55.

The passage 48 is connected to an accumulator passage 62 in which a plurality of first accumulators 61 are provided via an electromagnetic switching valve 57, a check valve 58, and a passage 59, and a pressure sensor 63 that detects pressure accumulated in the first accumulator 61 is connected to the accumulator passage 62. The accumulator passage 62 is connected to a passage 66 via an electromagnetic regeneration valve 64 and a check valve 65. The passage 66 extends from the tank 21 and is connected to an intake-side passage 68 connected to an intake port of the assist pump motor 15 via a check valve 67. A pressure sensor 69 that detects an intake-side pressure of the assist pump motor is provided in the intake-side passage 68.

The assist pump motor 15 has a function of switching the electromagnetic regeneration valve 64 to a communicating position when accumulation in the first, accumulator 61 progresses and the accumulator pressure has increased to a predetermined value to suck in the operating oil from the first accumulator 61 to thereby reduce an increase in the pressure of the accumulator 61 and pressurize the sucked operating oil and supply the same to the rod side chamber 7cr of the boom cylinder 7c1.

The boom energy recovery valve 31 includes a pilot-operated main switching valve 71. The main switching valve 71 controls supply of pilot pressure with the aid of an electromagnetic switching valve 72 to thereby switch the relation between the passages 73, 74, 75, and 76.

The passage 73 is connected to one port of one of drift reduction valves—a drift reduction valve 77—and an external passage 32 drawn from the head-side end of the boom cylinder 7c1 is connected to the other port of the drift reduction valve 77 via a passage 78. The drift reduction valve 77 controls opening/closing and an opening degree of ports by controlling pilot pressure in a spring chamber with the aid of a pilot valve 79. A passage 81 branched from the passage 30 is connected to the passage 73 via a check valve 82.

The passage 74 is connected to the passage 30 and is also connected to one port of the other one of the drift reduction valves—a drift reduction valve 83. An external passage 33 drawn from the head-side end of the other boom cylinder 7c2 is connected to the other port of the drift reduction valve 83 via an inner passage 84. The drift reduction valve 83 controls opening/closing and an opening degree of ports by controlling a pilot pressure in spring chamber with the aid of a pilot valve 85.

The pilot valves 79 and 85 allow the spring chambers of the drift reduction valves 77 and 83 to communicate with the passages 78 and 84 or a passage 86 to the tank 21.

The passage 75 branches into a check valve 87, a spring check valve 88, and a passage to a variable throttle valve 89. A passage that passes through the check valve 87 is connected to an external passage 38 and an inner passage 90. A relief valve 91 and a check valve 92 are provided between the passage 90 and the passage 78, and a relief valve 93 and a check valve are provided between the passage 90 and the passage 84. Further, a pressure sensor 95 and an adjustment valve 96 are provided between the passage 78 and the passage 84, and a pressure sensor 97 and an adjustment valve 98 are provided between the passage 84 and the passage 90. The spring check valve 88 and the variable throttle valve 89 are connected to the tank passage 50 via a passage 99.

The passage 76 is connected to the passage 59 via a passage 105 that passes through a check valve 104, and the pressure of the passage 105 is detected by a pressure sensor 106. A passage branched from the passage 105 is connected to the tank passage 50 via a relief valve 107, a passage 108, and the passage 99. The passage 108 communicates with the passage 105 via the check valve 109, and the passage 105 is connected to the passage 108 via an electromagnetic switching valve 110.

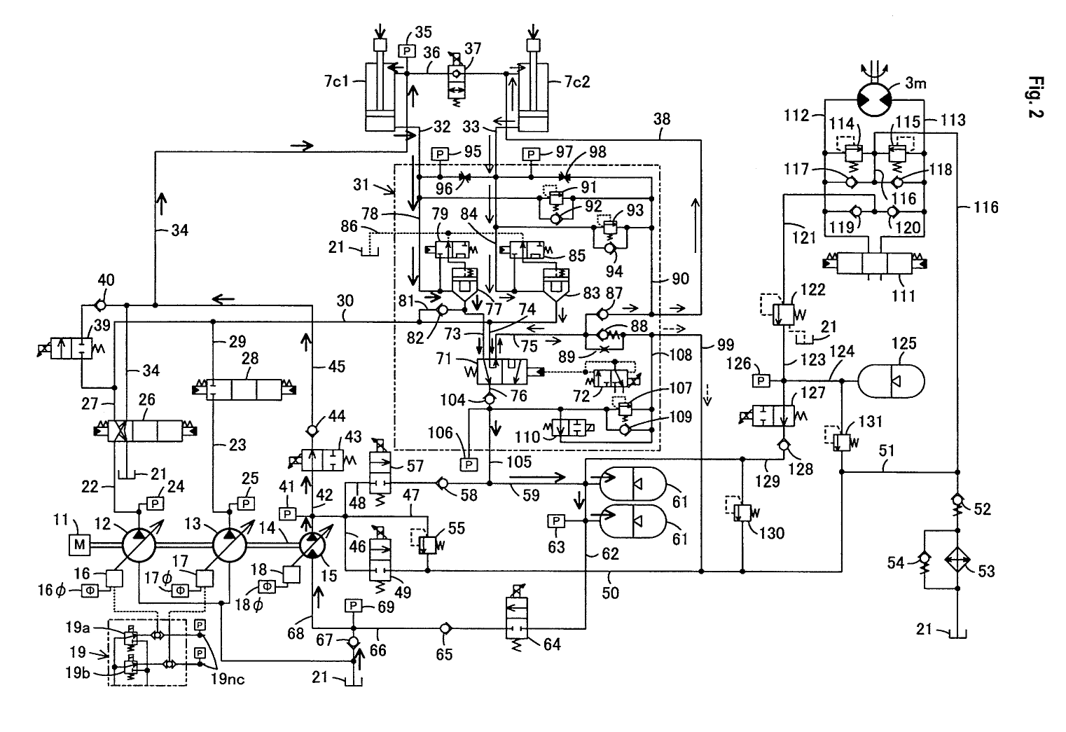

As illustrated in FIG. 1, the accumulation circuit A is a circuit which extends from the passage 32 drawn from the head-side end of one of the boom cylinders—the boom cylinder 7c1—and reaches the first accumulator 61 via the passage 78, the drift reduction valve 77, the passage 73, the main switching valve 71, the check valve 104, and the passage 105 in the boom energy recovery valve 31. The accumulation circuit A has, as illustrated in FIG. 2, a function of accumulating the oil pushed from the head side of the boom cylinder 7c1 in the accumulator 61.

As illustrated in FIG. 1, the regeneration circuit B is a circuit which extends from the passage 33 drawn from the head-side end of the other boom cylinder 7c2 and reaches the rod-side end of the other boom cylinder 7c2 via the passage 84, the drift reduction valve 83, the passage 74, the main switching valve 71, the passage 75, the check valve 87, and the passage 38 in the boom energy recovery valve 31. The regeneration circuit B has a function of regenerating the oil pushed from the head side of the boom cylinder 7c2 and supplying the same to the rod side of the boom cylinder 7c2.

Opposing relief valves 114 and 115 and opposing check valves 117 and 118 are provided between the passages 112 and 113 of the motor driving circuit C that connects the swinging motor 3m and a swinging control valve 111 that controls the swinging direction and speed of the swinging motor 3m. A makeup passage 116 having a tank passage function of returning the oil discharged from the motor driving circuit C to the tank 21 and a makeup function of making up for the operating oil to the motor driving circuit C is connected between the relief valves 114 and 115 and between the check valves 117 and 118. Operating oil is supplied from the makeup passage 116 to a side where there is a possibility of the occurrence of vacuum in the passages 112 and 113 via the check valves 117 and 118 with pressure which does not exceed the spring biasing pressure of the spring check valve 52.

Further, the passages 112 and 113 of the motor driving circuit C communicate with a swing energy recovery passage 121 via check valves 119 and 120. The passage 121 is connected to a passage 123 via a sequence valve 122 in which source pressure on an inlet side rarely changes with back pressure on an outlet side and is also connected to a second accumulator 125 via a passage 124. The pressure associated with the second accumulator 125 is detected by a pressure sensor 126. The passage 123 is connected to the accumulator passage 62 of the first accumulator 61 by a passage 129 that passes through a check valve 128 and an electromagnetic switching valve 127. The passage 129 is connected to the tank passage 50 via a relief valve 130, and the second accumulator 125 is connected to the tank passage 51 via a relief valve 131.

In the circuit configuration described above, the swash angle sensors 16φ, 17φ, and 18φ, the pressure sensors 24, 25, 35, 41, 63, 69, 95, 97, 106, and 126 input the detected swash angle signals and the pressure signals to an in-vehicle controller (not illustrated). Moreover, the electromagnetic switching valves 39, 43, 57, 72, 110, and 127, the electromagnetic unload valve 49, and the electromagnetic regeneration valve 64 are turned on and off according to a driving signal output from the in-vehicle controller (not illustrated) or switched by a proportional operation according to the driving signal. Moreover, the boom control valves 26 and 28, the swinging control valve 111, and other hydraulic actuator control valves (not illustrated) (including traveling motor, stick cylinder, and bucket cylinder control valves and the like) are pilot-operated by a manual operating valve (so-called a remote control valve) which is lever-operated or pedal-operated by an operator in the cab 5, and the pilot valves 79 and 85 of the drift reduction valves 77 and 83 are also pilot-operated in an interlinked manner.

Hereinafter, the contents of the functions controlled by the in-vehicle controller will be described.

(Engine Power Assisting Function)

An engine power assisting function of the hydraulic pressure circuit having the above-described configuration will be described.

FIGS. 1 and 2 illustrate a circuit state when a boom lowering operation of lowering the boom 7 is performed. The operating oil discharged from the assist pump motor 15 functioning as a pump is pressurized and supplied to the rod side of one of the boom cylinders—the boom cylinder 7c1—via the electromagnetic switching valve 43. The operating oil pushed from the head side of the boom cylinder 7c1 to the passages 32 and 78 is controlled so as to flow from the passage 73 to the passage 76 via the drift reduction valve 77 of the boom energy recovery valve 31 by the main switching valve 71. The operating oil is accumulated in the first accumulator 61 via the passages 105 and 59.

At the same time, the operating oil pushed from the head side of the other boom cylinder 7c2 to the passages 33 and 84 is controlled so as to flow from the passage 74 to the passage via the drift reduction valve 83 of the boom energy recovery valve 31 by the main switching valve 71 and is regenerated on the rod side of the boom cylinder 7c2 via the check valve 87 and the passage 38.

In this manner, the boom energy recovery valve 31 performs accumulation in the first accumulator 61 during the boom lowering operation and regeneration on the rod side of the boom cylinder 7c2 at the same time with the aid of the main switching valve 71 and the drift reduction valve 77 and 83.

FIG. 1 illustrates a circuit state in which the assist pump motor 15 functions as a hydraulic pump while consuming the hydraulic pressure energy accumulated in the accumulator 61. When the electromagnetic regeneration valve 64 is switched to the communicating position, the assist pump motor 15 functioning as a hydraulic pump sucks in the operating oil accumulated in the first accumulator 61. In this case, since the electromagnetic switching valve 43 is switched to the communicating position, the operating oil discharged from the assist pump motor 15 is pressurized and supplied to the rod side of the boom cylinder 7c1, and the boom 7 is lowered with strong force.

FIG. 2 illustrates a circuit state where the assist pump motor 15 functions as a hydraulic pump concurrently with the accumulation of pressure in the accumulator 61. The electromagnetic switching valve 43 is at the communicating position and the electromagnetic regeneration valve 64 is switched to the blocking position, whereby the operating oil is accumulated in the accumulator 61 and the operating oil sucked from the tank 21 by the assist pump motor 15 is pressurized and supplied to the rod side of the boom cylinder 7c1.

Moreover, when the boom raising operation (not illustrated) of raising the boom 7 is performed, the main switching valve 71 of the boom energy recovery valve 31 is switched to stop the accumulation of pressure in the first accumulator 61 and regeneration of pressure on the rod side of the boom cylinder 7c2, and the operating oil supplied from the main pumps 12 and 13 to the passage 30 via the boom control valves 26 and 28 is controlled so as to flow from the passage 74 to the passage 73 by the switched main switching valve 71 and is guided from the passages 73 and 30 to the head side of both boom cylinders 7c1 and 7c2 via the drift reduction valves 77 and 83. Moreover, operating fluid is returned from the rod side of the boom cylinders 7c1 and 7c2 to the tank 21 via the output passage 34 and the boom control valve 26.

In this manner, the engine power assisting function accumulates the head-side pressure of one of the boom cylinders—the boom cylinder 7c1—in the first accumulator 61 and regenerates the head-side pressure of the other one of the boom cylinders—the boom cylinder 7c2—on the rod side of the boom cylinder 7c2.

(Boom Speed Compensating Function)

Next, a boom speed compensating function will be described.

The boom speed compensating function is a function of allowing the assist pump motor 15 to consume the accumulator pressure of the first accumulator 61 to suppress a pressure increase and pressurizing the operating oil and supplying the operating oil from the assist pump motor 15 to the chamber 7cr on the rod side of the boom cylinder 7c1 in order to solve a problem that the boom lowering speed decreases when the pressure of the first accumulator 61 is high (that is, a problem that the operating speed of a stick cylinder 8c, a bucket cylinder 9c, or a swinging motor 3m that cooperates with the boom cylinders 7c1 and 7c2 increases).

In order to realize the boom speed compensating function, the electromagnetic switching valve 43 provided in the middle of the passage 45 capable of communicating with the assist pump motor 15 and the rod side of the boom cylinder 7c1 is switched to the communicating position during the boom lowering operation as illustrated in FIG. 1. In this way, the operating oil is preferentially supplied from the assist pump motor 15 to the chamber 7cr on the rod side of the boom cylinder 7c1 associated with pressure accumulation of the first accumulator 61 via the passages 45 and 34. Moreover, the electromagnetic regeneration valve 64 provided in the middle of the passages 62 and 66 capable of communicating with the first accumulator 61 and the assist pump motor 15 is switched to the communicating position. In this way, the operating oil supplied to the first accumulator 61 is sucked by the assist pump motor 15 to thereby diminish an increase in the accumulator pressure.

The effect of the boom speed compensating function will be described.

The assist pump motor 15 performs a pumping action when the operating oil is accumulated in the first accumulator 61 via the electromagnetic switching valve 57 and when the pressurized oil is supplied to the rod side of the boom cylinder 7c1 as illustrated in FIGS. 1 and 2.

When the accumulator pressure of the first accumulator 61 detected by the pressure sensor 63 is low or moderate, the electromagnetic switching valve 43 is opened and the electromagnetic regeneration valve 64 is closed as illustrated in FIG. 2, whereby the assist pump motor 15 supplies the operating oil sucked from the tank 21 to the rod side of the boom cylinder 7c1. Moreover, the potential energy of the heavy working unit 6 during the boom lowering operation is converted into hydraulic pressure pushed from the head side of the boom cylinder 7c1, and the pressure is effectively accumulated in the first accumulator 61 via the drift reduction valve 77, the main switching valve 71, and the like.

When the accumulator pressure of the first accumulator 61 has reached a high pressure level, the electromagnetic regeneration valve 64 disposed between the assist pump motor 15 and the first accumulator 61 is opened as illustrated in FIG. 1 so that the pressurized oil supplied to the first accumulator 61 from the chamber 7ch on the head side of the boom cylinder 7c1 is consumed by the assist pump motor 15 as suction oil. In this way, it is possible to suppress an increase in the accumulator pressure of the first accumulator and to secure the boom lowering speed. Moreover, it is possible to secure the ability to cooperate with other hydraulic actuators such as the swinging motor 3m.

The advantageous effects of the boom speed compensating function will be described.

If the boom speed compensating function is not provided, when the pressure of the first accumulator 61 increased when cooperating with the boom cylinders 7c1 and 7c2 and other hydraulic actuators, a high boom cylinder rod pressure is required to lower the boom 7. However, in the conventional open center circuit, the operating oil discharged from the main pump 12 flows into a hydraulic actuator having a lower load and the operating oil is not supplied to the rod side of the boom cylinder 7c. As a result, the boom 7 is not lowered. Since the boom speed compensating function is provided, it is possible to supply the operating oil discharged from the assist pump motor 15 exclusively to the rod side of the boom cylinder 7c1 and to perform the boom lowering operation even if the pressure of the first accumulator 61 is high to a certain extent.

Moreover, when the pressure of the first accumulator 61 increases, the rod-side pressure of the boom cylinder 7c1 increases, and thus, a problem that the boom 7 is not lowered occurs in particular in a folded posture of the working unit 6 wherein the inertial moment of the working unit 6 decreases. One solution to this problem is to return the drift reduction valves 77 and 83 and the main switching valve 71 of the boom energy recovery valve 31 to the neutral position to cut the pressure accumulation in the first accumulator 61 when the pressure of the first accumulator 61 reaches to a high pressure level. In this case, a pressure shock or an abrupt speed change occurs during the boom operation and an operability problem occurs.

Thus, when the pressure of the first accumulator 61 exceeds a predetermined threshold, the boom energy recovery valve 31 is not switched and the accumulation of the oil in the first accumulator 61, having returned from the head side of the boom cylinder 7c1 and reached the first accumulator 61 is diminished, and the oil is consumed by the assist pump motor 15 as illustrated in FIG. 1. In this way, it is possible to prevent an abrupt change in the circuit switching and to suppress an abnormal pressure increase in the first accumulator 61. Thus, the pressure on the head side of the boom cylinder 7c1 can be returned effectively to the intake port side of the assist pump motor 15, which leads to energy saving.

(Swing Energy Recovery Function)

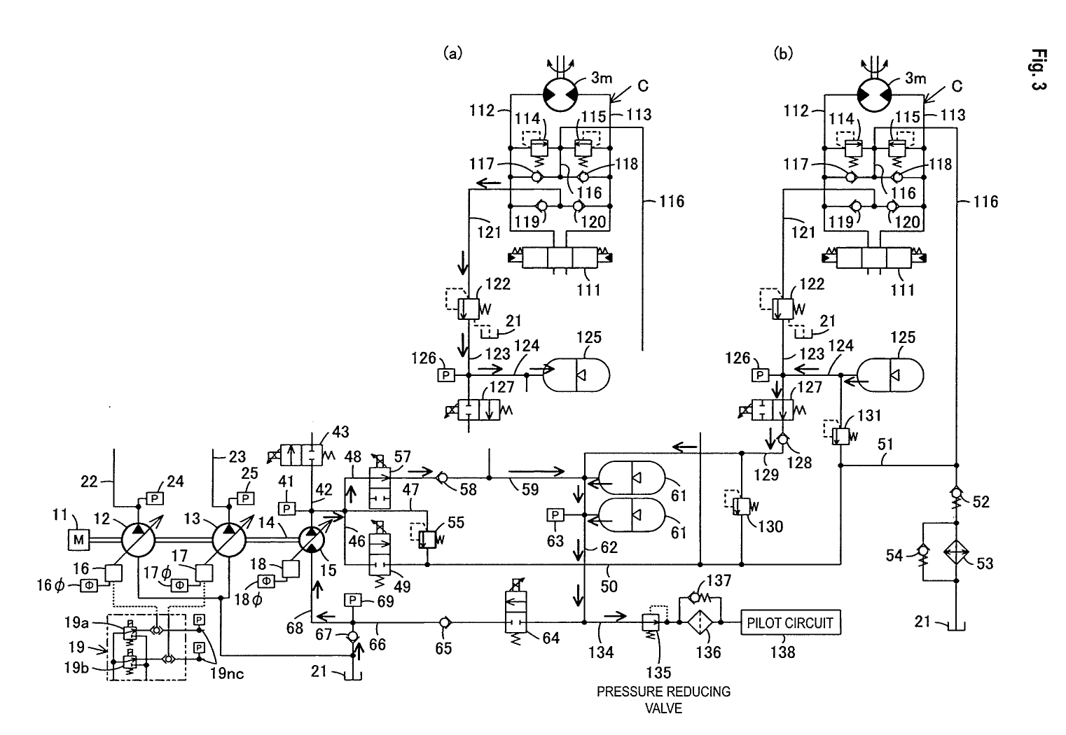

FIG. 3 illustrates a swing energy recovery function. The sequence valve 122 in which the source pressure on the inlet side rarely changes with the back pressure on the outlet side is employed in order to absorb driving energy before the accumulator pressure exceeds the setting pressure of the relief valves 114 and 115 when the rotation of the swinging motor 3m is accelerated so that the accumulator pressure does not exceed the relief setting pressure and to absorb the braking energy discharged outside from the passages 112 and 113 of the motor driving circuit C when the rotation stops so that the braking energy is accumulated in the second accumulator 125 as hydraulic pressure energy. The operating oil leaking from the sequence valve 122 when rotation accelerates and decelerates is recovered and accumulated in the second accumulator 125.

Further, in order to reduce energy loss as much as possible, the electromagnetic switching valve 127 that opens and closes the passage 129 between the first and second accumulators 61 and 125 is provided so that the accumulator pressure is also discharged from the second accumulator 125 when the pressure discharged from the first accumulator 61 ha reached a pressure level equal to the pressure of the second accumulator 125.

That is, in order to improve energy recovery efficiency and to reduce pressure drop as much as possible, the electromagnetic switching valve 127 is provided between the first and second accumulators 61 and 125 having different pressure levels.

Moreover, as illustrated in FIG. 3A, the driving energy and the braking energy relieved from the relief valves 114 and 115 when the rotation of the swinging motor 3m is accelerated and stopped are accumulated in the second accumulator 115 which takes out the energy and converts the same into pressure before the relief valves 114 and 115 acts, whereby the relieved swing energy is recovered. In this case, the electromagnetic switching valve 127 is closed and the operating oil leaking from the sequence valve 122 during acceleration and deceleration is recovered and accumulated in the second accumulator 125.

Although not illustrated in the drawings, since vacuum may occur on the upstream side of the swinging motor 3m, the electromagnetic unload valve 49 is opened from the start point of a swinging operation to detect an amount of arm operation and an operation speed of a swing operation lever, the swash angle of the assist pump motor 15 is controlled according to the detection values, and an amount of oil corresponding to the operation amount and the operation speed of the swing operation lever is supplied from the assist pump motor 15 to a passage in the motor driving circuit C where there is a possibility of the occurrence of vacuum via the electromagnetic unload valve 49, the tank passages 50 and 51, and the makeup passage 116.

Moreover, as illustrated in FIG. 3B, the electromagnetic switching valve 127 is opened and the operating oil pressure accumulated in the second accumulator 125 is discharged and supplied to the passage 62 of the first accumulator 61.

FIG. 3B illustrates an example in which the assist pump motor 15 is driven as a pump, the electromagnetic switching valve 57 is opened to supply the operating oil sucked up from the tank 21 to the first accumulator 61, and the hydraulic pressure obtained by the assist pump motor 15, the first accumulator 61, and the second accumulator 225 is used as a pilot pressure.

(Pilot Backup Function)

That is, FIG. 3B illustrates a pilot backup function realized by the assist pump motor 15 and the accumulators 61 and 125. A pilot backup circuit is formed such that a pressure reducing valve 135 is connected to the passage 134 drawn from the accumulator passage 62 to which pressurized oil is supplied from the assist pump motor 15 and the accumulators 61 and 125, the pilot circuit 138 is connected to the pressure reducing valve 135 via a filter 136 and a filter protecting spring check valve 137, and the pilot pressure is supplied to the pilot circuit 138.

The pilot circuit 138 is a circuit that pilot-operates the main control valves 26, 28, and 111, the pilot valves 79 and 85, and the like, for example, and supplies a predetermined pilot pressure set to the pressure reducing valve 135 to the pilot circuit 138 as a pilot source pressure.

The pressurized pilot oil is based on the supply from the first and second accumulators 61 and 125 and is supplemented by the operating oil supplied from the assist pump motor 15 as illustrated in FIG. 3B when the pressure sensors 63 and 126 detect a decrease in the pressure energy accumulated in the accumulators 61 and 125.

After the engine starts, the accumulation of pressure in the first accumulator 61 is performed immediately by the assist pump motor 15, and predetermined pressure set to the pressure reducing valve 135 is also supplied to the pilot circuit 138 via the pressure reducing valve 135.

Since this pilot backup function eliminates the need of the conventional pilot pump, it is possible to suppress the cost.

Next, the advantageous effects of the embodiment will be described.

As illustrated in FIG. 1, when the pressure accumulation of the first accumulator 61 that accumulates the operating oil pushed from one chamber 7ch of the boom cylinder 7c1 progresses so that the accumulator pressure has increased and the lowering speed of the boom cylinders 7c1 and 7c2 has decreased, the operating oil supplied to the accumulator 61 is consumed by the assist pump motor 15 to thereby suppress an increase in the accumulator pressure as illustrated in FIG. 1. Thus, it is possible to diminish a decrease in the speed of the boom cylinders 7c1 and 7c2 without switching a circuit and to prevent the occurrence of a shock during the switching, which may occur when a circuit is switched to cope with the decrease in the speed of the boom cylinders 7c1 and 7c2.

As illustrated in FIG. 2, since the assist pump motor 15 supplies the operating oil to the chamber 7cr on the rod side of the boom cylinder 7c1, it is possible to reduce the amount of operating oil supplied from the main pumps 12 and 13. Thus, it is possible to suppress an adverse effect on other hydraulic actuators such as the swinging motor 3m that shares the main pumps 12 and 13 and to secure the ability to cooperate with the other hydraulic actuators.

As illustrated in FIGS. 3A and 3B, since the pressure reducing valve 135 reduces the hydraulic pressure supplied from at least one of the assist pump motor 15 and the accumulator 61 and uses the same as pilot source pressure, it is possible to eliminate the use of the conventional pilot pump.

The operating oil supplied to the first accumulator 61 mounted on the excavator HE is consumed by the assist pump motor 15 to suppress an increase in the accumulator pressure. Thus, it is possible to diminish the decrease in the speed of the working unit 6 and to prevent the occurrence of a shock during the switching, which may occur when a circuit is switched to cope with the decrease in the speed of the working unit 6.

That is, since a shock occurs during the switching if a circuit is switched to cope with the decrease in the boom lowering speed, by decreasing the amount of the operating oil pushed from the boom cylinder 7c1 and accumulated in the first accumulator 61 so that the operating oil is consumed by the assist pump motor 15, it is possible to prevent a decrease in the boom lowering speed and to suppress energy loss.

### INDUSTRIAL APPLICABILITY

The present invention is industrially applicable to business operators associated with manufacturing and selling hydraulic pressure circuits or working machines.

### EXPLANATION OF REFERENCE NUMERALS

HE: Excavator as working machine

1: Vehicle body

6: Working unit

7: Boom

7c1: Boom cylinder as hydraulic pressure cylinder

7cp: Piston

7ch: One chamber

7cr: The other chamber

11: Engine

12, 13: Main pump

15: Assist pump motor as assist pump

61: Accumulator

135: Pressure reducing valve

138: Pilot circuit

1. A hydraulic pressure circuit comprising:
a main pump driven by an engine;
a hydraulic pressure cylinder including a piston operated with an operating fluid supplied from the main pump and one chamber and another chamber partitioned by the piston;
an accumulator that accumulates the operating fluid pushed from the one chamber of the hydraulic pressure cylinder; and
an assist pump that sucks in the operating fluid from the accumulator when pressure accumulation in the accumulator progresses such that an accumulator pressure increases.

2. The hydraulic pressure circuit according to claim 1, wherein
the assist pump pressurizes the operating fluid sucked from the accumulator and supplies the pressurized operating fluid to the other chamber of the hydraulic pressure cylinder.

3. The hydraulic pressure circuit according to claim 1, further comprising:
a pressure reducing valve that reduces hydraulic pressure supplied from at least one of the assist pump and the accumulator to a predetermined pressure level; and
a pilot circuit that uses operating fluid pressure connected to the pressure reducing valve as a pilot source pressure.

4. A working machine comprising:
a vehicle body;
a working unit mounted on the vehicle body; and
the hydraulic pressure circuit according to claim 1, provided in the hydraulic pressure cylinder that operates the working unit.

5. The working machine according to claim 4, wherein
the working unit includes a boom rotated in a vertical direction, wherein
the hydraulic pressure cylinder is a boom cylinder that moves the boom in the vertical direction.

6. The hydraulic pressure circuit according to claim 2, further comprising:
a pressure reducing valve that reduces hydraulic pressure supplied from at least one of the assist pump and the accumulator to a predetermined pressure level; and
a pilot circuit that uses operating fluid pressure connected to the pressure reducing valve as a pilot source pressure.

7. A working machine comprising:
a vehicle body;
a working unit mounted on the vehicle body; and
the hydraulic pressure circuit according to claim 2, provided in the hydraulic pressure cylinder that operates the working unit.

8. The working machine according to claim 7, wherein
the working unit includes a boom rotated in a vertical direction, wherein
the hydraulic pressure cylinder is a boom cylinder that moves the boom in the vertical direction.

9. A working machine comprising:
a vehicle body;
a working unit mounted on the vehicle body; and
the hydraulic pressure circuit according to claim 3, provided in the hydraulic pressure cylinder that operates the working unit.

10. The working machine according to claim 9, wherein
the working unit includes a boom rotated in a vertical direction, wherein
the hydraulic pressure cylinder is a boom cylinder that moves the boom in the vertical direction.

11. A working machine comprising:
a vehicle body;
a working unit mounted on the vehicle body; and
the hydraulic pressure circuit according to claim 6, provided in the hydraulic pressure cylinder that operates the working unit.

12. The working machine according to claim 11, wherein
the working unit includes a boom rotated in a vertical direction, wherein
the hydraulic pressure cylinder is a boom cylinder that moves the boom in the vertical direction.
